(19) United States
(12) Patent Application Publication
(10) Pub. No.: US 2018/0295795 A1
(43) Pub. Date: Oct. 18, 2018

(54) Debris Tolerant Drip Emitter

(71) Applicant: Rain Bird Corporation, Azusa, CA (US)

(72) Inventor: John James Wlassich, Pasadena, CA (US)

(21) Appl. No.: 15/952,510

(22) Filed: Apr. 13, 2018

Related U.S. Application Data
(60) Provisional application No. 62/486,782, filed on Apr. 18, 2017.

(51) Int. Cl. A01G 25/02

(52) U.S. Cl. CPC A01G 25/023; A01G 2025/006; A01G 25/02

(57) ABSTRACT

There is provided a drip emitter for providing low flow irrigation. The drip emitter includes a mixing chamber system to maintain flow of debris with the fluid flowing through the emitter. The chamber system includes an inner and outer chamber. Both chambers receiving reduced pressure fluid compared to the conduit providing the fluid for the drip emitter. The outer chamber is supplied with greater reduced pressure fluid as compared to the fluid supplied to the inner chamber. A first check valve controls discharge of fluid for irrigation, and a second check valve controls the flow between the first and second chambers. The first and second chambers expand and contract in response to the operation of the check valves to provide the mixing of the debris with the fluid flowing through the emitter.

### CROSS-REFERENCE TO RELATED APPLICATIONS

This application claims benefit of U.S. Provisional Application No. 62/486,782, filed Apr. 18, 2017, which is hereby incorporated herein by reference in its entirety.

### FIELD

The subject matter of this application relates to emitter devices for irrigation systems and, more particularly, to a debris tolerant drip emitter.

### BACKGROUND

Irrigation systems use emission devices to provide water to vegetation. One type of emission device is a drip emitter. Drip emitters may be attached to the interior or exterior of irrigation piping, and as water flows through the piping, the emitters modify a relatively high rate of water flow to a relatively low rate. The low flow rate can be as low as 0.5 gallons per hour. It is common for emitters to have a body housing a torturous path that decreases the rate of water flow through the emitter. This permits a low flow drip emission of water to the vegetation.

It is common for irrigation piping to become contaminated with debris, such as sand and dirt. To maintain a desired supply of water to vegetation with drip emitters, it is necessary to keep the drip emitters from being obstructed by debris. If debris accumulates in the drip emitter, it may result in hindered performance of the emitter and shorten the life expectancy.

Emitters have been fitted with flushing technology to address debris. This technology flushes debris from constricted areas in the drip emitters. The present invention addresses debris in a different manner than flushing technology.

### BRIEF DESCRIPTION OF THE DRAWINGS

FIG. 1 is a perspective view of a debris tolerant emitter in a conduit;

FIG. 2 is a plan view of the debris tolerant emitter of FIG. 1 with the top enclosure removed; and

FIG. 3 is an expanded plan view of a portion the debris tolerant emitter of FIG. 2.

### DETAILED DESCRIPTION

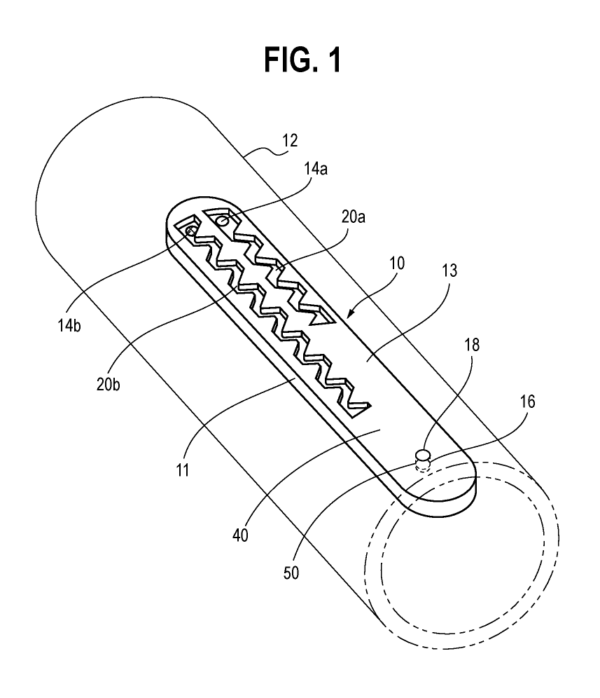

Referring to FIG. 1, a debris tolerant drip emitter 10 is attached to the inside of a conduit 12 for supplying water at a low flow rate to vegetation. The conduit 12 carries water within an irrigation system and, preferably, includes numerous emitters 10 spaced along the conduit 12. Water enters the emitter 10 through a pair of inlets 14a, 14b, and after flowing through the emitter 10, the water exits through a discharge tube 16. Water exits the discharge tube 16 at an outlet 18 aligned with a hole in the conduit 12, supplying a low flow drip emission to the vegetation. The low flow can be at a rate in the range of 0.5 gallons per hour to 20 gallons per hour.

The drip emitter 10 includes a body 11 with an upper surface 13. The upper surface 13 preferably has a radius of curvature that aligns with that of the conduit 12, such that the emitter 10 can be bonded securely to the inside wall of the conduit 12, creating an enclosed pressure-reduction chamber from the inlets 14a,b to the outlet 18. The following system can also be used with emitters that attach to the outside wall of a conduit (e.g., an on-line emitter).

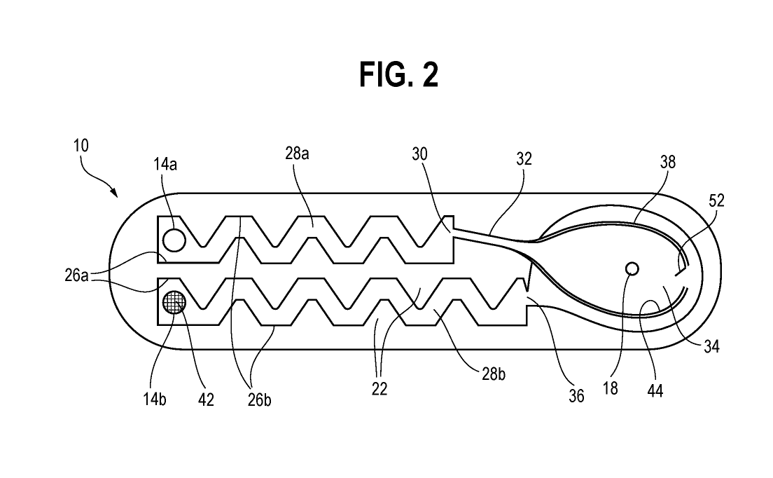

With reference to FIG. 2, the emitter 10 has two pressure reducing flow channels 20a,b that are integrated into one portion of the body 11 of the emitter 10 and reduce the flow rate of water after it enters through the inlets 14a,b. The pressure reducing flow channels 20a,b are comprised of alternating teeth 22 extending from inner walls 26a and outer walls 26b of each pressure reducing flow channel 20a,b (see also FIG. 1), forming two tortuous pathways 28a,b. The shape of the tortuous pathways 28a,28b cause the water to zig-zag, thus slowing the flow rate of water in the emitter 10. As illustrated, one tortuous path 28a is shorter than the tortuous path 28b. Therefore, the water exiting tortuous path 28a will have a higher pressure than water exiting tortuous path 28b.

In this embodiment, the water flows through the inlet 14a and into the shorter tortuous path 28a. The water then exits the tortuous path 28a through an outlet 30 and enters an extended flow channel 32. The extended flow channel 32 extends to an inner chamber 34 having a chamber wall 44. The inlet 14a is shown without a filter to allow debris to flow into the tortuous path 28a and eventually be discharged with the fluid for irrigation. This permits debris in the conduit 12 to be flushed from the system. Moreover, the diameter of inlet 14a can be sized such that large debris may not pass through the inlet 14a while allowing fine particulate matter to enter. Alternatively, the inlet 14a may include a filter to also control the size of debris allowed into the emitter 10.

At the longer tortuous path 28b, water flows through the inlet 14b, which is fitted with a filter 42, and enters the tortuous path 28b. The water then flows through the longer tortuous path 28b and exits at an outlet 36, passing into an outer chamber 38 having an inner chamber wall 46 and an outer chamber wall 48. Alternatively, the inner wall of the outer chamber could be the same as the outer wall of the inner chamber. The emitter 10 has an enclosure 40 covering the two chambers 34,38 (see FIG. 1). As noted above, due to the shorter length of the first tortuous path 28a, the rate of flow of water into the inner chamber 34 is higher than the rate of flow into the outer chamber 38. The chambers 34,38 are made of flexible, elastomeric materials allowing for expansion and contraction of the chambers 34,38. The inner chamber 34 is of lower durometer than the outer chamber 38.

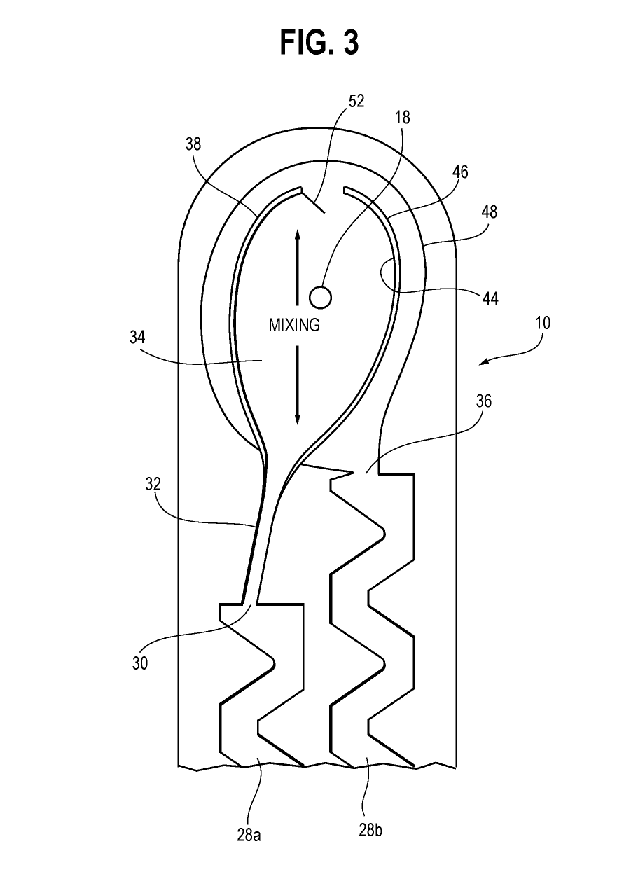

With reference to FIG. 3, water flowing into the outer chamber 38 arrives from the longer tortuous path 28b at a lower flow rate than that of the water flowing into the inner chamber 34. Therefore, the pressure within the outer chamber 38 will be lower than the pressure in the inner chamber 34. The elastomeric composition of the chambers 34,38 allows them to expand and contract as pressure may change in the chambers 34,38. The pressure difference between the inner 34 and outer 38 chambers means that the inner chamber wall 46 can expand and contract more than the outer chamber wall 48 due to its higher relative pressure. However, the outer wall 48 of the outer chamber 38 may expand as well, since it is of higher pressure than the surrounding ambient environment (i.e., its pressure is greater than the average 1013.25 mbar air pressure at sea-level).

Water accumulates in the inner chamber 34 until there is sufficient pressure to open a check valve 50 (see FIG. 1) to the discharge tube 16 to expel the water to the outside vegetation. The opening of the check valve 50 provides an expulsion of water. As the water in the inner chamber 34 is emitted, the pressure in the inner chamber 34 drops, and the inner chamber 34 contracts. Once the pressure in the inner chamber 34 drops below the pressure in the outer chamber 38, a second check valve 52 opens inward towards the inner chamber 34, and a subsequent inflow of water from the outer chamber 38 into the inner chamber 34 occurs. The inward-only action permitted by the flow through the check valve 52 ensures that the water in the inner chamber 34 (which may contain debris) does not exit into the outer chamber 38.

The flow of water into the inner chamber 34 from the outer chamber 38 causes a mixing action within the inner chamber 34 because it combines with the average motion of the water in the downstream direction of the emitter 10. That is, water moves back and forth in the inner chamber 34, yet has an aggregate motion in the downstream direction of the emitter outlet 18. The episodic expulsion of water also ensures that debris is not sucked back into the emitter 10 from outside the discharge tube 16. The constant mixing motion of the water leaves any grit in the emitter 10 in suspension, inhibiting blockage and, therefore, enhancing performance and extending the life expectancy.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the technological contribution. The actual scope of the protection sought is intended to be defined in the following claims.

What is claimed is:

1. A drip emitter comprising:
a body having a first inlet and a second inlet;
a first pressure reducing path formed at the body to communicate with the first inlet;
a second pressure reducing path formed at the body to communicate with the second inlet, the second pressure reducing path providing greater pressure reduction than the first pressure reducing path;
a first pressure chamber at the body communicating with the second pressure reducing path;
a second pressure chamber inside the first pressure chamber and communicating with the first pressure reducing path, the first pressure chamber and the second pressure chamber allow for expansion and contraction to provide for mixing in the second pressure chamber; and
an outlet to supply fluid from first pressure chamber for irrigation.

2. The drip emitter of claim 1 wherein the second pressure chamber includes a first port communicating with the outlet, the first port having a first check valve to control discharge of fluid from the second pressure chamber.

3. The drip emitter of claim 2 wherein the second pressure chamber includes a second port communicating with the first pressure chamber, the second port having a second check valve to control fluid flow between the first pressure chamber and the second pressure chamber.

4. The drip emitter of claim 1 further comprising a filter at the second inlet.

5. The drip emitter of claim 1 further comprising a cover attached to the body over at least the first pressure chamber and the second pressure chamber.

6. A drip emitter comprising:
a first reduced pressure source;
a second reduced pressure source, the first reduced pressure source supplying higher pressure than the second pressure source;
a first pressure chamber communicating with the second reduced pressure source;
a second pressure chamber disposed inside the first pressure chamber and communicating with the first reduced pressure source;
a first port communicating with the second pressure chamber, the first port associated with a first check valve, the first check valve controlling emission of water from the drip emitter;
a second port communicating with the second chamber, the second port associated with a second check valve, the second check valve controlling flow between the first pressure chamber and the second pressure chamber; and
wherein the first and second pressure chambers allow for expansion and contraction and cooperate with the first and second check valves to cause mixing of fluid and debris in the first pressure chamber.

7. A drip line comprising:
a tube;
a plurality of emitters fitted to the tube; and
at least one of the plurality of emitters comprising:
a body having a first inlet and a second inlet;
a first pressure reducing path formed at the body to communicate with the first inlet;
a second pressure reducing path formed at the body to communicate with the second inlet, the second pressure reducing path providing greater pressure reduction than the first pressure reducing path;
a first pressure chamber at the body communicating with the second pressure reducing path;
a second pressure chamber inside the first pressure chamber and communicating with the first pressure reducing path, the first pressure chamber and the second pressure chamber allow for expansion and contraction to provide for mixing in the second pressure chamber; and
an outlet in the tube to supply fluid from first pressure chamber for irrigation.

8. The drip emitter of claim 7 wherein the second pressure chamber includes a first port communicating with the outlet, the first port having a first check valve to control discharge of fluid from the second pressure chamber.

9. The drip emitter of claim 8 wherein the second pressure chamber includes a second port communicating with the first pressure chamber, the second port having a second check valve to control fluid flow between the first pressure chamber and the second pressure chamber.

10. The drip emitter of claim 7 further comprising a filter at the second inlet.

11. The drip emitter of claim 7 further comprising a cover attached to the body over at least the first pressure chamber and the second pressure chamber.
